(19) United States
(12) Patent Application Publication
(10) Pub. No.: US 2011/0224372 A1
(43) Pub. Date: Sep. 15, 2011

(54) PROCESS FOR PREPARING LINEAR POLYCARBONATE WITH IMPROVED IMPACT PROPERTIES

(76) Inventors: Guenter Jueptner, Hammah (DE); Bernhard Elbert, Stade (DE)

(21) Appl. No.: 13/130,004

(22) PCT Filed: Nov. 16, 2009
(86) PCT No.: PCT/US09/64522

§ 371 Date: May 18, 2011

Related U.S. Application Data
(60) Provisional application No. 61/117,315, filed on Nov. 24, 2008.

(51) Int. Cl. C08L 69/00; C08G 64/16

(52) U.S. Cl. 524/841; 528/196

(57) ABSTRACT

The present invention relates to an improved process for preparing linear polycarbonates having an improved technique for adding a coupling catalyst compound, specifically the addition of the coupling catalyst at two or more separate, different points in the process. Linear polycarbonate resins prepared by said process demonstrate a lower level of polycarbonate oligomers and an improved balance of properties, in particular improved impact strength and lower ductile brittle transition temperature.

### CROSS REFERENCE STATEMENT

This application claims the benefit of U.S. Provisional Application No. 61/117,315, filed Nov. 24, 2008.

### FIELD OF THE INVENTION

The present invention relates to an improved process for preparing linear polycarbonates having an improved technique for adding a coupling catalyst compound, specifically the addition of the coupling catalyst at two or more separate, different points in the process. Linear polycarbonate resins prepared by said process demonstrate a lower level of polycarbonate oligomers and an improved balance of properties, in particular improved impact strength and lower ductile brittle transition temperature.

### BACKGROUND OF THE INVENTION

Linear polycarbonate resins and processes for preparing linear polycarbonates are known in the art. In the known processes for the preparation of linear polycarbonate resins, a dihydric phenol, such as bisphenol A is reacted with carbonate precursor such as phosgene. Such processes also use mono-functional compounds such as monophenols as chain terminators, and phase transfer catalysts such as tertiary amines that act as coupling catalysts which increase the polymer molecular weight.

Typically, linear polycarbonate resins produced by conventional processes can contain a fraction of low molecular weight polycarbonate oligomers. Often, the presence of such oligomers in a linear polycarbonate resin can result in an advantageous performance property, for example improved flow by lowering the polycarbonate resin's viscosity. Improved flow is very desirous for certain molded articles, for example, those with hard to fill thin sections and/or long flow paths.

However, a polycarbonate oligomer component in a linear polycarbonate resin may adversely affect other properties, for example increasing brittleness by increasing the resin's ductile brittle transition temperature or lowering impact properties such as Izod impact strength and/or falling dart impact. Polycarbonate oligomers may also migrate out of the polycarbonate resin during the process of manufacturing fabricated articles, thus forming an unwanted residue on the article and/or the manufacturing equipment. For example, this undesirable effect is referred to as plate-out (or sometimes as juicing) when the process is extrusion or during injection molding and the fabricated article is an injection molded article. Such plate-out can fowl injection molds as well as result in an unwanted residue on the surface of the injection molded article. Markets where such properties are critical are digital storage applications (e.g., CDs, DVDs, and optical storage) and medical equipment applications.

In the known linear polycarbonate resin processes, such as disclosed in U.S. Pat. Nos. 5,200,496; 5,321,116; 5,412,064; and 6,225,436 and for the branched polycarbonate resin process disclosed in U.S. Pat. Re No. 27,682; and U.S. Pat. No. 6,288,204, it is taught that the coupling catalyst, such as triethyl amine (TEA), can be added in a single dose at varying times or points in the process but there is no criticality associated with the addition timing nor disclosure of benefits to resin performance. Further, U.S. Pat. No. 7,057,005, which is directed solely to a process to manufacture branched polycarbonate resins, discloses that the coupling catalyst can be added in two separate doses at different points in the process. However, while U.S. Pat. No. 7,057,007 discloses the resulting branched polycarbonate resins have improved flow properties by lowering the resin's viscosity at increases shear rates, it is completely silent as to the effects on levels of polycarbonate oligomers, impact properties, and/or plate-out.

Therefore, there is a continuing need for an improved linear polycarbonate process providing a better of combination lower levels of polycarbonate oligomers in the product and improved resin performance, specifically improved impact properties and/or plate-out performance.

### SUMMARY OF THE INVENTION

An object of the present invention is a new process for preparing linear polycarbonate resins in which the coupling catalyst compound functions more effectively and provides a linear polycarbonate resin with lower polycarbonate oligomer levels, better impact strength, and ductile brittle transition temperature performance.

Accordingly, a first embodiment of the present invention is a method for producing a linear polycarbonate by split addition of a coupling catalyst, wherein the coupling catalyst is added in two or more portions at two or more separate, different points in the polycarbonate manufacturing process

In a second embodiment, the present invention is a process for producing linear polycarbonate, preferably having a lower level of polycarbonate oligomers, by providing for split addition of the coupling catalyst. More specifically, the present invention is an interfacial process for producing a linear polycarbonate composition from a dihydric phenol, a carbonate precursor, and a monophenolic chain terminator using a coupling catalyst which process comprises the sequential steps of:

a) combining a dihydric phenol, base and water to form the reaction mixture,

b) then adding at least part of the carbonate precursor and the water immiscible organic solvent and reacting the polymerization mixture, partially oligomerizing the dihydric phenol,

c) then adding a monophenolic chain terminator and base to the reaction mixture,

d) at the same time as or after c) add a first portion of the coupling catalyst,

e) adding the balance of the carbonate precursor (if any) and continuing the reaction of the polymerization mixture,

f) adding a second portion of the coupling catalyst,

g) completing the polymerization reaction.

In a preferred embodiment the first portion of coupling catalyst added in step c) is added to the oligomerizing reaction mixture at the point where the Mw is between about 1,200 and about 4,500 g/mole, preferably where the Mw is between about 2,000 and about 3,500 g/mole.

In another embodiment, the first addition of the coupling catalyst is in an amount of from 0.1 to 20 mole percent of the total coupling catalyst amount that is added.

In another preferred embodiment, the second coupling catalyst component is added to the reaction mixture at the point where the Mw has increased to about 4,000 to 10,000.

The linear polycarbonate polymerization process and product improvements which are the subject of this invention relate to the timing of the addition of the coupling catalyst to the polycarbonate reaction mixture. It has surprisingly been found that the level of polycarbonate oligomers is reduced when its addition is split and a minor portion of the coupling catalyst is added relatively early in the process and the balance of the coupling catalyst is added later. Using this technique for addition of the coupling catalyst, the present invention provides polycarbonate resins with improved impact properties and an improved process for their production using otherwise generally known reactants and processes.

### BRIEF DESCRIPTION OF THE DRAWINGS

FIG. 1 is a flow chart illustrating the interfacial process for producing polycarbonate resin.

### DETAILED DESCRIPTION OF THE INVENTION

The dihydric phenols employed in the practice of the present invention are generally known in the carbonate polymerization art and in which the only reactive groups under condensation polymerization conditions are the two phenolic hydroxyl groups. Useful dihydric phenols are for example those of the general formula HO—Z—OH, wherein Z comprises a mono- or poly-aromatic diradical of 6-30 carbon atoms, to which the phenolic oxygen atoms are directly linked. The aromatic group(s) may comprise one or more heteroatoms and may be substituted with one or more groups, for example one or more oxygens, nitrogens, sulfur, phosphorous and/or halogens, one or more monovalent hydrocarbon radicals, such as one or more alkyl, cycloalkyl or aryl groups and/or one or more alkoxy and/or aryloxy groups. Preferably, both phenolic hydroxy groups in the dihydric phenol HO—Z—OH are arranged in para-positions on the aromatic ring(s).

The dihydric phenols employed in the process of the present invention include the bis(aryl-hydroxy-phenyl)alkylidenes including their aromatically and aliphatically substituted derivatives, such as disclosed in U.S. Pat. No. 2,999,835; U.S. Pat. No. 3,038,365; U.S. Pat. No. 3,334,154 and U.S. Pat. No. 4,299,928; and aromatic diols such as described in U.S. Pat. No. 3,169,121.

Preferred examples of dihydric phenols of the general formula HO—Z—OH are bis(hydroxyphenyl)fluorenes, such as 9,9-bis-(4-hydroxyphenyl) fluorene; dihydroxy benzenes and the halo- and alkyl-substituted dihydroxy benzenes, such as hydroquinone, resorcinol, or 1,4-dihydroxy-2-chlorobenzene; alpha,alpha′-bis(hydroxyphenyl)-diisopropylbenzenes; dihydroxybiphenylenes, such as 4,4′-dihydroxydiphenyl; the halo- and alkyl substituted dihydroxybiphenylenes; bis(hydroxyphenyl)alkanes, such as bis(4-hydroxylphenyl)methane, 1,1-bis(4-hydroxyphenyl)ethane, 1,1-bis(4-hydroxyphenyl)propane, or, most preferably, 2,2-bis(4-hydroxyphenyl)propane (“bisphenol A”); alkyl-, aryl- or halosubstituted bis(hydroxyphenyl)alkanes, such as 1-phenyl-1,1-bis(4-hydroxyphenyl)ethane (“bisphenol AP”), 2,2-bis(3,5-dibromo-4-hydroxyphenyl)propane (“tetrabromo bisphenol A”), 2,2-bis(3,5-dimethyl-4-hydroxyphenyl)propane (“tetramethyl bisphenol A”); optionally alkyl-, aryl- or halosubstituted bis(hydroxyphenyl)cycloalkanes; optionally alkyl-, aryl- or halosubstituted bis(hydroxyphenyl)ethers; optionally alkyl-, aryl- or halosubstituted bis(hydroxyaryl)sulfones, preferably bis(hydroxyphenyl)sulfones; or bis(hydroxyphenyl)sulfoxides. Other examples of suitable dihydric phenols are listed in U.S. Pat. No. 4,627,949, column 2, line 68-column 3, lines 1-22, in U.S. Pat. No. 4,962,144, column 2, lines 17-46 and in EP 423 562, page 2, lines 24-55 and page 3, lines 1-19. Mixtures of two or more dihydric phenols may also be used, for example a mixture comprising 1-99 percent of bisphenol A and 99-1 weight percent of another dihydric phenol, such as 9,9-bis-(4-hydroxyphenyl) fluorene.

Among the most preferred dihydric phenol suitable for production of polycarbonate in the present invention are bisphenol A, bisphenol A P, bisphenol F, tetrabromo bisphenol A, and tetramethyl bisphenol A. The most preferred dihydric phenol is bisphenol A.

A carbonate precursor suitable for use in the present invention contains leaving groups which can be displaced from the carbonyl carbon in attack by the anion of a dihydric phenol compound, and includes but is not necessarily limited to carbonyl halides or acyl halides, of which, the most preferred is phosgene. The carbonate precursor, preferably phosgene, is contacted with the dihydric phenol compound in the aqueous alkaline solution and can be added as a solution in the water-immiscible non-reactive organic solvent and thoroughly mixed with the aqueous phase or can be bubbled into the reaction mixture in the form of a gas and preferentially dissolve and locate in the organic phase. The carbonate precursor is typically used in an amount of 1.0 to 1.8, preferably 1.2. to 1.5, moles per mole of dihydric phenol compound.

A chain terminator is a monofunctional compound containing a functional group, frequently a hydroxyl group, which will produce an anion capable of displacing an unreacted hydroxyl or carbonic acid ester group which remains on the end of the oligomer or polymer chain. Representative of the terminators which are useful for the production of polycarbonates in the present invention are phenol and the derivatives thereof, saturated aliphatic alcohols, metallic sulfites, alkyl acid chlorides, trialkyl- or triarylsilanols, monohalosilanes, amino alcohols, trialkyl alcohols, aniline and methylanaline. Of these, phenol, para-t-butyl phenol (PTBP), p-cumyl phenol and para-t-octyl phenol (4-(1, 1, 2, 2-tetramethylbutyl)-phenol or PTOP) are the most preferred for use in the present invention.

In this process, the total amount of coupling catalyst is generally added in an amount equal to or greater than about 1 to about 150 milimoles (mmoles) per mole of dihydric phenol compound. The catalyst is preferably added in amounts equal to or greater than about 10, preferably at least about 25 and more preferably equal to or greater than about 50 mmoles per mole of dihydric phenol compound. The catalyst is preferably added in amounts equal to or less than about 150, preferably equal to or less than about 100 and more preferably equal to or less than about 75 mmoles per mole of dihydric phenol compound. As will be discussed below, the catalyst addition is started during oligomerization and preferably split with a second part added later in the polymerization process.

Such coupling catalysts include a tertiary amine such as triethylamine (TEA), dimethyl amino pyridine or N,N-dimethyl aniline; a cyclic aza compound such as 2,2,6,6-tetramethyl piperidine or 1,2-dimethylimidazole; an iminoether or iminocarboxylate compound such as 1-aza-2-methoxy-1-cycloheptene or t-butyl-cyclohexyliminoacetate; or a phosphonium, sulfonium, arsonium or quaternary ammonium compound such as cetyl triethylammonium bromide. Tertiary amines are the preferred coupling catalysts for use in improved process according to the present invention and include trimethylamine, triethylamine, tributylamine, and 4-N,N-dimethylaminopyridine.

Polycarbonate resins may be produced by the transesterification process where aromatic diesters of carbonic acid are condensed with dihydroxydiaryls in the presence of basic catalysts, solution polymerization where Bisphenol A is phosgenated in a mixture of chlorinated hydrocarbons and pyridine, or by the interfacial polymerization process. The polycarbonate resins of the present invention are preferably made by the interfacial process which can be done either batchwise or continuously.

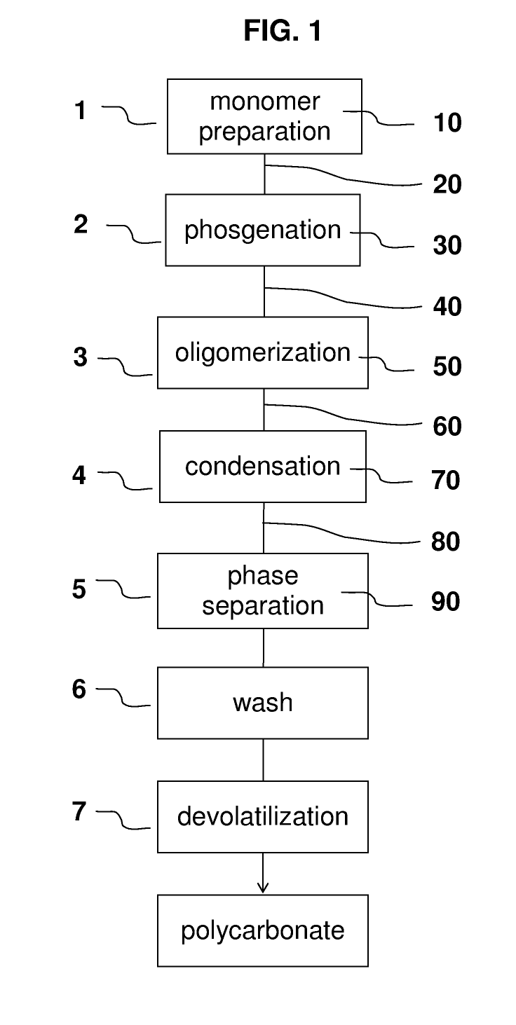

As is known, a standard interfacial process (also referred to as phase boundary process) for aromatic carbonate polymer polymerization (FIG. 1) involves the reaction of the dihydric phenol such as a bisphenol A, and the carbonate precursor such as phosgene or other disubstituted carbonic acid derivative, or a haloformate (such as a bishaloformate of a glycol or dihydroxy benzene). The initial stage of the interfacial process is the monomer preparation step 1. The dihydric phenol compound is at least partially dissolved and deprotonated in an aqueous alkaline solution to form bisphenolate (phenate). The carbonate precursor, typically phosgene, is supplied to the process 2, optionally dissolved in an inert organic solvent which forms the second of the two phases which initially serves as a solvent for the phosgene passed in, but in the course of the reaction also acts as a medium for the arylchlorocarbonates and oligocarbonates formed during the oligomerization process 3.

The aqueous alkaline solution has a pH range from equal to or greater than about 9.5, preferably equal to about 14, preferably equal to or greater than about 12 to less than or equal to about 14, and can be formed in water by adding base such as caustic soda, NaOH, or other bases such as alkali metal and alkaline earth metal carbonates, phosphates, bicarbonates, oxides and hydroxides. Base is typically used over the course of the interfacial polymerization and further added to the reaction mixture where appropriate to maintain the proper pH. In total this usually amounts to the addition of base in an amount of 2 to 4, preferably 3 to 4, moles base per mole of dihydric phenol compound. The base, such as caustic soda, is added to the reaction mixture to adjust the pH of the mixture to a level at which the dihydric phenol compound is at least partially converted to dianionic form. A reducing agent such as sodium sulfite or sodium dithionite can also be advantageously added to the reaction mixture as well.

The other phase of the two phase mixture is a non-reactive organic solvent immiscible with water and in which the carbonate precursor and polycarbonate product are typically soluble. Representative solvents include chlorinated hydrocarbons such as methylene chloride, 1,2-dichloroethane, tetrachloroethane, chlorobenzene, and chloroform, to which tetrahydrofuran, dioxane, nitrobenzene, dimethyl sulfoxide, xylene, cresol or anisole may be added, if desired.

Both phases are mixed in a manner which is sufficient to disperse or suspend droplets of the solvent containing the carbonate precursor in or otherwise contact the precursor with the aqueous alkaline mixture. Reaction between the carbonate precursor and the phenate reactant in the aqueous phases yields primarily the bis-ester of the carbonate precursor with the dihydric phenol compound which can further react with more dihydric phenol units to form longer chain oligomers 3. Oligomer is defined as a polycarbonate chain having 15 or less repeating units. Some dihydric phenol does not react in this phosgenation step and remains as a monomer but will react later with the chloroformate end-groups, formed in the phosgenation, and some remains as shorter chain, intermediate bis-esters. For example, if the carbonate precursor is an acyl halide such as phosgene, these intermediates are primarily bischloroformates, although some end groups may instead be a terminator residue, phenolate ion or unreacted hydroxy group. With the addition of the coupling catalyst, the coupling reactions occur between ester moieties to couple/polymerize the oligomers into the carbonate polymer 4. Conventional processes have added the entire amount of catalyst at one time either during 30, or at a point after phosgenation 40, 50 or 60. Tertiary amines, specifically triethyl amine, are effective condensation catalysts. For instance, U.S. Pat. Nos. 6,225,436; 5,321,116; and 5,412,064 teach addition of the entire amount of catalyst at 30 or 40, 50 and 60, respectively.

The desired degree of polymerization depends on several factors such as efficient mixing of the emulsion, the alkali content of the aqueous phase (e.g., reaction mixture pH), reaction temperature, residence times in different parts of the reactor sequence, etc. Typically, the polycarbonate forming reaction can be run at a pH from above 8.5 to 14, and at a temperature between 0° C. to 100° C., although usually not in excess of the boiling point (corrected for the operating pressure) of the solvent used. Frequently, the reaction is run at a temperature of 0° C. to 95° C. The desired molecular weight of the polycarbonate is dictated by the ratio of monomer to chain terminator.

A chain terminator is typically used and can be added to with or after the monomer preparation step 10 or 20, during or after phosgenation step 30 or during or after the oligomerization and/or condensation steps 40, 50, 60, or 70. Any terminator capable of attacking a hydroxyl, a chloroformate, or carbonic acid ester end group on a polymer chain is also capable of undesirably either (1) attacking unreacted molecules of the initial charge of the carbonate precursor or (2) displacing end groups before a chain has an opportunity to grow to the desired length. The practice in the art of adding chain terminator to the reaction mixture prior to introduction of the carbonate precursor consequently allows for the formation of undesired carbonate byproducts by the occurrence of both of the aforementioned results. Carbonate byproduct content detracts from the desirable properties and qualities of polycarbonate, and in most applications, may be seen as an impurity therein. For example, low molecular weight carbonates have a negative impact on the mechanical properties of the final polycarbonate composition.

It was surprisingly found that adding the coupling catalyst in at least two portions (i.e., a first portion, a second portion, a third portion, etc.), each portion at a different or distinct time (i.e., at a different time before, during, or after specific steps) during the coupling/polymerization reaction results in a lower level of oligomers and improved impact properties such as lower ductile brittle transition temperature and greater toughness. The first portion of coupling catalyst addition is sometimes referred to as being added “early” or “during” oligomerization, e.g., at 40 or 50. Polycarbonate resins with the most improved impact properties are observed by adding from about 0.1 to about 10 percent of the total amount of the coupling catalyst early in the polymerization process. Surprisingly, oligomer reduction up to 50 percent has been observed.

In conventional processes where TEA or a similar coupling catalyst is used in the production of linear polycarbonate, the whole amount of the coupling catalyst is typically added at one time, sometimes referred to as a “single portion addition”, for instance after the phosgene has been added to the reaction 30 or 40 or after the complete oligomerization and reaction of the phosgene and diphenol to chloroformate and sodium phenate groups 50, 60 or 70.

Instead, in the process according to the present invention for split addition of the coupling catalyst, roughly the same amount or somewhat reduced amounts of coupling catalyst are used as in conventional single portion addition processes, but it is split into at least two portions with the first portion being added early during the initial oligomerization step and the second being added later. This first coupling catalyst portion is added to the oligomerizing reaction mixture at the point before or during initial oligomerization occurs, 40 or 50, for example where the weight average molecular weight (Mw) is between about 1,200 and about 4,500 g/mole and preferably between about 2,000 and about 3,500 g/mole. Subsequently, a second addition and/or the balance of the coupling catalyst, i.e., the “second portion” or “late” coupling catalyst component, is added to the reaction mixture at the point oligomerization/polymerization (oligomer chain coupling) occurs, 60, or 70. For example, the second portion of coupling catalyst may be added where the Mw has increased to at least about 4,000, preferably to at least about 10,000 and is more preferably between about 4,000 and about 10,000 g/mole.

According to the present invention it is found that the amount of the first portion of coupling catalyst addition should be equal to or greater than about 0.1 percent of the total amount of coupling agent that is added, preferably equal to or greater than about 0.5 percent, more preferably equal to or greater than about 2 percent and even more preferably equal to or greater than about 3.5 percent of the total amount of coupling agent that is added. According to the present invention, the amount of the first portion of coupling catalyst addition is preferably equal to or less than about 20 percent of the total coupling agent amount that is added, more preferably equal to or less than about 10 percent, and even more preferably equal to or less than about 7 percent of the total coupling agent amount that is added.

According to the present invention when the coupling catalyst is added in two portions, it is found that the amount of the second portion of coupling catalyst addition should be equal to or greater than about 80 percent of the total amount of coupling catalyst that is added, preferably equal to or greater than about 90 percent, and even more preferably equal to or greater than about 93 percent of the total amount of coupling catalyst that is added. According to the present invention when the coupling catalyst is added in two portions, it is found that the amount of the second portion of coupling catalyst addition should be equal to or less than about 99.1 percent of the total coupling catalyst amount that is added, more preferably equal to or less than about 99.5 percent, even more preferably equal to or less than about 98 percent, and even more preferably equal to or less than about 96.5 percent of the total coupling catalyst amount that is added.

The final stage of the interfacial process comprises obtaining the finished polycarbonate resin. Upon completion of polymerization, the organic and aqueous phases are separated 5 to allow purification of the organic phase and recovery of the polycarbonate product therefrom. The organic phase is washed as needed with dilute acid, water and/or dilute base until free of unreacted monomer, residual process chemicals such as the coupling catalyst and/or other electrolytes 6. Recovery of the polycarbonate product can be effected by spray drying, steam devolatilization, direct devolatilization in a vented extruder, precipitation by use of an anti-solvent such as toluene, cyclohexane, heptane, methanol, hexanol, or methyl ethyl ketone, or combinations thereof 7.

The resulting product from split addition of the coupling catalyst are observed to have lower oligomer content with improved impact strength and lower ductile brittle transition temperature with no adverse effects in the process or on other polymer properties such as molecular weight and flow. Not to be held to any particular mechanism, it is theorized that the measurable change is due to differences in the polycarbonate chain growth mechanism. One of two chain growth mechanisms is favored, thus suppressing the other, resulting in a lower oligomer content and a narrower molecular weight distribution in the polycarbonate resin. Further, we believe that this lower oligomer content is what translates to lower plate-out performance for the polycarbonate resins of the present invention. The degree of plate-out can be predicted by themogravimetric analysis (TGA). TGA simulates plate-out conditions in processing equipment (e.g., injection molding machines) on a lab scale, the greater the weight loss by TGA, the greater the potential plate-out in an injection molding machine.

### EXAMPLES

The invention is illustrated in the following examples. The following general polymerization method for Examples 1 and 2 and Comparative Example A is employed. A 20 liter pilot plant reactor is used. The targeted melt flow rate (MFR) at 300° C., under 1.2 kg load for the final polycarbonate product in each of these examples is 80 g/10 min according to ASTM 1238.

The pilot plant reactor is a temperature controlled, agitated, 20-litre, jacketed glass reactor. The supplies of water, caustic, dichloromethane, tertiary-butyl-phenol solution and triethylamine solution are connected with a control system to provide proper feed rates and are padded with nitrogen to prevent oxidation of the described raw materials. A pH electrode in the reactor allows the addition of additives at a controlled pH level during phosgenation. For the polymerizations described below the following raw material amounts and conditions are used:
Bisphenol-A (BPA): 0.700 kg (3 moles);
Water: 3.870 kg;
Caustic solution (30 weight percent NaOH in water): 0.9 kg;
Methylene chloride: 2.000 kg;
Phosgene flow: 0.06 g/s (0.6 mmole/s);
Total phosgene feed: 405 g (4.1 mole);
Reaction temperature: between 20° C. and 40° C., normally 25° C.;
Agitator speed: 250 rpm;
Tertiary-butyl phenol (PTBP): A certain portion—dependent on the aimed melt flow rate of the finished polymer—of a solution of 60 g or 400 mmoles PTBP in 1200 grams methylene chloride); and
Triethyl amine (TEA): 6.6 g TEA (65 mmol TEA) in 80 ml methylene chloride.

The bisphenol-A (0.70 kg) is deoxygenated in a glass flask under vacuum for 10 minutes. Then it is kept under nitrogen to remove traces of oxygen. The deoxygenated bisphenol-A is added into the constantly stirred 20-litre double wall glass reactor which is purged with nitrogen. To dissolve the bisphenol-A, argon purged water (3.87 kg) and the caustic (0.9 kg of 30 weight percent sodium hydroxide) are added. During dissolution nitrogen is blanketed above the mixture to exclude oxygen. After all the bisphenol-A is dissolved, 2.0 kg dichloromethane is added, the reactor is closed and stirred for 20 minutes under an argon atmosphere and then phosgenation is started. During phosgenation, and throughout the rest of the polymerization reaction, the reaction mixture is constantly stirred. At the beginning of the reaction the initial pH is about 13. The phosgenation oligomerization reaction provides primarily the following intermediate along with some by-products:

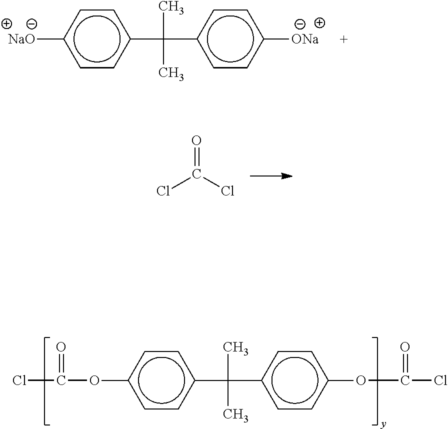

where y is generally less than about 10 to 15. About a third of the oligomers are end capped as sodium salt.

After about 37.5 minutes, a third of the total phosgene amount has been added (135 grams, 1.36 moles), the tertiary-butyl phenol (PTBP) is fed to the reaction to control molecular weight. After about 75 minutes following the phosgene addition, 600 grams of 30 percent caustic (i.e., 180 grams NaOH) is added. The first portion (amount in percent based on percent of total amount of TEA solution added) of the TEA solution (6.6 g grams TEA in 80 ml methylene chloride) is added following the caustic addition. This is after about 80 minutes and about three quarters of the total phosgene (270 g or 2.7 mole) is added. At this time, the polymer molecular weight is about 1,500 g/mole. After the completion of the phosgene addition, the phosgenation is stopped and the system is purged with nitrogen for 20 minutes. Then the second portion of TEA (remaining amount of the 6.6 g grams of TEA in 80 ml dichloromethane, amount in percent based on percent of total amount of TEA solution added) is added, providing about 2400 ppm TEA in the organic phase. After complete addition of the TEA coupling catalyst, 2 kg methylene chloride is added and the solution is mixed for 15 minutes to finish the coupling reaction. When stiffing is stopped the solution starts to separate into aqueous and organic phase. The polymer solution is tested to be free of phosgene and chloroformate end groups by phosgene tape (i.e., paper impregnated with 4-(4-nitrobenzyl)pyridine). Then the aqueous phase and the organic phase are separated, the organic phase is washed to remove impurities from the polymer solution and the polycarbonate is recovered by devolatilization, dried, and extruded.

The process variables and polymer characteristics are summarized in Table 1. In Table 1:

“Mw”, “Mn”, and “Dispersity” are weight average molecular weight, number average molecular weight, and poly dispersity, respectfully, and are determined by gel permeation chromatography (GPC) using a diode-array-detector (DAD) and a viscosity-detector and

“Oligomer Content” is determined by high performance liquid chromatography (HPLC) using a HPLC 110 high performance liquid chromatography machine equipped with a SPHERISORB™ ODS 2 3 micrometer (150×4.6 mm) column. The eluent is tetrahydrofuran (THF) with a flow rate of 0.5 millimeter per minute (ml/min). The results are reported in weight percent (wt %) based on the total weight of the sample.

TABLE 1

| Example | | 1 | 2 |
|---|---|---|---|
| Comparative Example | A | | |
| Aimed MFR, g/10 min | 80 | 80 | 80 |
| Actual MFR, g/10 min | 77 | 72 | 68 |
| TEA-Total Amount Added, g | 6.6 | 6.6 | 6.6 |
| First Portion TEA, % of total | 0 | 1.0 | 1.5 |
| Second Portion TEA, % of total | 100 | 99.0 | 98.5 |
| Mw (g/mole) | 16340 | 16620 | 16800 |
| Mn (g/mole) | 7470 | 7800 | 7630 |
| Dispersity | 2.19 | 2.13 | 2.11 |
| Oligomers Content wt % | 5.0 | 4.6 | 4.5 |

As can be seen in the Examples of the invention, the oligomers content is decreased up to 10 percent by the split addition of the coupling catalyst TEA, without a significant change in the molecular weight. At the same time an advantageous narrower molar weight distribution by a decreasing dispersity is achieved.

For Examples 3 and 4 and Comparative Examples B and C, larger scale runs are performed on a continuous production scale plant, operating at a similar concentration-time-profile as the pilot plant reactor. The targeted MFR of the production plant polymers for Example 3 and Comparative Example B is 3 g/10 min, for Example 4 and Comparative Example C, it is 30 g/10 min under conditions of 300° C. and a load of 1.2 kg. The process variables and polymer characteristics are summarized in Table 2. Impact and tensile property testing is performed on 3.0 mm thick injection molded test specimens. In Table 2:

“MFR” is as determined according to ASTM 1238 using a Zwick 4105 plastometer under conditions of 300° C. and a load of 1.2 kg;

“Izod” is Notched Izod Impact strength as determined at 23° C. according to ASTM D256 using a Zwick impact machine;

“Falling Dart” is Falling Dart impact strength at 23° C. and −40° C. as determined according to ASTM D1709;

“DBTT” is ductile brittle transition temperature as determined by Notched Izod Impact measurements at different temperatures. Notched samples are cooled in a freezer for a minimum of one hour to the desired temperature. Conditioned samples are tested according to ASTM D256. Brittleness temperature is calculated as follows:

T_{b}=Tₕ+ΔT^{[S/100}-(1/2)]}

where:
T_{b}=brittleness temperature
Tₕ=highest temperature at which failure of the entire specimen fails (i.e., no ductile failure)
ΔT=temperature increment (° C.)
S=sum of percentage of breaks at each temperature (from a temperature corresponding to no breaks down to and including T;

“TGA” is themogravimetric analysis is performed on a TG/DTA 220 employing a temperature gradient of 20° K per minute under a nitrogen atmosphere from room temperature to 350° C., then held at 350° C. for three hours. The loss of sample mass is recorded as percent loss based on the initial weight of the sample; and

“Tensile Strain” is determined according to ASTM D638.

TABLE 2

| Example | | 3 | | 4 |
|---|---|---|---|---|
| Comparative Example | B | | C | |
| Aim MFR, g/10 min | 30 | 30 | 3 | 3 |
| Actual MFR, g/10 min | 39 | 34 | 2 | 2 |
| First Portion TEA, | 0 | 4 | 0 | 4 |
| % of total | | | | |
| Second Portion TEA, | 100 | 96 | 100 | 96 |
| % of total | | | | |
| Mw, g/mole | 19150 | 19670 | 36720 | 37820 |
| Mn, g/mole | 7810 | 8300 | 11920 | 13540 |
| Dispersity | 2.45 | 2.37 | 3.08 | 2.79 |
| Oligomers Content, wt % | 3.7 | 3.0 | 3.0 | 1.65 |
| Izod, J/m at 23° C. | 653 | 708 | — | — |
| Falling Dart, J/m at | 63.8 | 68.2 | — | — |
| 23° C. | | | | |
| Falling Dart, J/m at | 42.8 | 51.7 | — | — |
| −40° C. | | | | |
| DBTT, ° C. | −14.1 | −17.3 | — | — |
| TGA, % mass loss after | — | — | 25 | 15.7 |
| 3 hrs @350° C. | | | | |
| Tensile Strain, % | — | — | 74 | 123 |

As demonstrated in the Examples 3 and 4, the oligomers content of the polymers are decreased significantly by the split of the coupling catalyst and the molecular weight distribution (dispersity) is decreased at the same time. The higher Izod and falling dart impact values and the lower ductile brittleness temperature of the polymer in Example 3, made by the coupling catalyst split demonstrates, a higher toughness than that polycarbonate, made by addition of the whole portion of the coupling catalyst at the end of the reaction, Comparative Example B. The higher tensile strain of the polymer in Example 4, made by the coupling catalyst split demonstrates a higher toughness than that polycarbonate, made by addition of the whole portion of the coupling catalyst at the end of the reaction, Comparative Example C. Further, a lower plate-out behavior of the material in Example 4 versus Comparative Example C, made by split of the coupling catalyst addition, is demonstrated by the lower weight loss of this polymer, as measured by TGA.

1. A method for producing a linear polycarbonate by split addition of a coupling catalyst, wherein the coupling catalyst is added in two or more portions at two or more separate, different points in the polycarbonate manufacturing process.

2. An interfacial process for producing a linear polycarbonate composition from dihydric phenol, carbonate precursor, and monophenolic chain terminator using a coupling catalyst which process comprises the sequential steps of:
a) combining a dihydric phenol, base and water to form the reaction mixture,
b) then adding at least part of the carbonate precursor and the water immissible organic solvent and reacting the polymerization mixture, partially oligomerizing the dihydric phenol,
c) then adding a monophenolic chain terminator and base to the reaction mixture,
d) at the same time as or after c) add a first portion of the coupling catalyst,
e) adding the balance of the carbonate precursor (if any) and continuing the reaction of the polymerization mixture,
f) adding a second portion of the coupling catalyst,
g) completing the polymerization reaction.

3. The process according to claim 2 for producing a linear polycarbonate wherein the coupling catalyst added in step d) is added to the oligomerizing reaction mixture at the point where the Mw is between about 1,200 and about 4,500 g/mole.

4. The process according to claim 3 for producing a linear polycarbonate wherein the coupling catalyst is added to the oligomerizing reaction mixture at the point where the Mw is between about 2,000 and about 3,500 g/mole.

5. The process according to claim 4 for producing a linear polycarbonate wherein the second the coupling catalyst component is added to the reaction mixture at the point where the Mw has increased to at least about 4,000 to 10,000 g/mole.

6. The process according to claim 4 for producing a linear polycarbonate wherein the second the coupling catalyst component is added to the reaction mixture at the point where the Mw has increased to at least about 10,000.

7. A process according to claim 2 for producing a linear polycarbonate wherein the first addition of the coupling catalyst is in an amount of from 0.1 to 20 mole percent of the total coupling catalyst amount that is added.
